(19) United States
(12) Patent Application Publication
(10) Pub. No.: US 2026/0143353 A1
(43) Pub. Date: May 21, 2026

(54) WIRELESS SIGNAL RECEPTION DEVICE AND RECEIVING METHOD OF WIRELESS SIGNAL

(71) Applicant: LUXSHARE PRECISION INDUSTRY COMPANY LIMITED, Shenzhen (CN)

(72) Inventors: Guan Hsiung WANG, Shenzhen (CN); Wei Hsin CHEN, Shenzhen (CN)

(21) Appl. No.: 19/301,238

(22) Filed: Aug. 15, 2025

(30) Foreign Application Priority Data
Nov. 19, 2024 (CN) 202411665151.9

(51) Int. Cl. H04W 16/28; H04L 5/00; H04W 56/00; H04W 84/06

(52) U.S. Cl. CPC H04W 16/28; H04L 5/0051; H04W 56/0025; H04W 84/06

(57) ABSTRACT

A receiving method of a wireless signal performed by a wireless signal reception device includes: receiving the pilot signal and the velocity of the UAV by the antenna; performing a ground downlink signal reception and synchronization algorithm, including steps as follows: according to the position of the UAV, the position of the antenna and the transmission direction of the pilot signal, calculating an AoA; according to the frequency of the pilot signal, the velocity of the UAV and the AoA, calculating a doppler frequency shift; according to the doppler frequency shift, adjusting the frequency of the pilot signal; according to the preset time point corresponding to the pilot signal, adjusting the present time point of the pilot signal in a data symbol; according to the adjusted present time point, adjusting the sampling time point of the pilot signal. By the foregoing method, the doppler frequency shift is modified.

### CROSS-REFERENCE TO RELATED APPLICATIONS

This application claims the priority benefit of Chinese Patent Application Serial Number 2024116651519, filed on Nov. 19, 2024 the full disclosure of which is incorporated herein by reference.

### TECHNICAL FIELD OF THE INVENTION

The present disclosure is related to the technical field of communication and is particularly related to a wireless signal reception device and a receiving method of a wireless signal.

### DESCRIPTION OF THE PRIOR ART

An orthogonal frequency division multiplexing (OFDM) system is a communication system for transmitting data at a high speed which still has better stability during multipath interference and narrowband interference. However, the OFDM system is extremely sensitive to frequency shifts and timing shifts. The frequency shifts result from a doppler effect; the timing shifts are influenced by the multipath interference and the narrowband interference, and the boundary of each symbol could not be found due to the timing shifts, resulting in inter-carrier interference between subcarriers.

The communication between a current unmanned aerial vehicle (UAV) and a base station on the ground is implemented by the OFDM system to perform bidirectional data transmission. Nonetheless, the doppler frequency shifts are increased because the UAV moves relative to the base station; under the circumstance that doppler frequency shifts are increased and an adjacent channel has signal beams with big data, serious intra-cell interference would be generated.

### SUMMARY

The present disclosure provides a wireless signal reception device and a receiving method of a wireless signal to solve the problem of the frequency shifts and the timing shifts.

Based on the aforementioned descriptions, the present disclosure is to provide a wireless signal reception device. The wireless signal reception device is disposed on the ground, communicates with a UAV and includes an antenna and a processor. The antenna receives the pilot signal and the velocity of the UAV. The processor is electrically connected to the antenna and performs a ground downlink signal reception and synchronization algorithm, and the ground downlink signal reception and synchronization algorithm includes steps as follows: according to the position of the UAV, the position of the antenna and the transmission direction of the pilot signal, calculating an angle of arrival; according to the frequency of the pilot signal, the velocity of the UAV and the angle of arrival, calculating a doppler frequency shift; according to the doppler frequency shift, adjusting the frequency of the pilot signal; according to the preset time point corresponding to the pilot signal, adjusting the present time point of the pilot signal in a data symbol; according to the adjusted present time point, adjusting the sampling time point of the data symbol.

Based on the aforementioned descriptions, the present disclosure is to provide a receiving method of a wireless signal for a wireless signal reception device including an antenna and a processor. The wireless signal reception device is disposed on the ground and communicates with a UAV by the antenna. The receiving method of the wireless signal is performed by the processor and includes: receiving the pilot signal and the velocity of the UAV by the antenna; performing a ground downlink signal reception and synchronization algorithm, wherein the ground downlink signal reception and synchronization algorithm includes steps as follows: according to the position of the UAV, the position of the antenna and the transmission direction of the pilot signal, calculating an angle of arrival; according to the frequency of the pilot signal, the velocity of the UAV and the angle of arrival, calculating a doppler frequency shift; according to the doppler frequency shift, adjusting the frequency of the pilot signal; according to the preset time point corresponding to the pilot signal, adjusting the present time point of the pilot signal in a data symbol; according to the adjusted present time point, adjusting the sampling time point of the data symbol.

In view of the above descriptions, the wireless signal reception device and the receiving method of the wireless signal of the present disclosure modify the doppler frequency shift and solves the problem of frame synchronization by adjusting the frequency of the pilot signal and the sampling time point of the data symbol.

The aforementioned descriptions of the present disclosure are merely the outline of the technical solutions of the present disclosure. In order to understand the technical solutions of the present disclosure clearly and to implement the present disclosure according to the content of the specification, the better embodiments of the present disclosure given herein below with accompanying drawings are used to elaborate the present disclosure.

### BRIEF DESCRIPTION OF DRAWINGS

FIG. 1 depicts the configuration diagram of a frame.

FIG. 2A depicts the schematic diagram of a wireless signal reception device and a UAV according to one embodiment of the present disclosure.

FIG. 2B depicts the configuration diagram of the wireless signal reception device according to one embodiment of the present disclosure.

FIG. 3 depicts the flowchart of a receiving method of a wireless signal according to one embodiment of the present disclosure.

FIG. 4 depicts the flowchart of a ground downlink signal reception and synchronization algorithm according to one embodiment of the present disclosure.

FIG. 5 depicts the flowchart of a receiving method of a wireless signal according to another embodiment of the present disclosure.

FIG. 6A and FIG. 6B depict the flowchart of a step of determining whether frequency synchronization is complete and signal synchronization is complete to receive the data packet from the UAV according to another embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely one part of the embodiments of the present disclosure and not all embodiments of the present disclosure. Based on the embodiments of the present disclosure, all embodiments obtained by a person skilled in the art without any inventive steps shall fall within the scope of protection of the present disclosure.

It should be noted that the terms “first”, “second”, etc. in the specification and claims of the present disclosure and in the accompanying drawings are used to distinguish similar objects and not used to describe a particular order or sequence. Furthermore, the terms “comprising” and “having”, and any variation thereof, are intended to encompass a non-exclusive inclusion, for example, a series of steps or units comprising processes, methods, systems, products or equipment do not need to be limited to those steps or units clearly listed but may include other steps or units not clearly listed or inherent to those processes, methods, products or equipment.

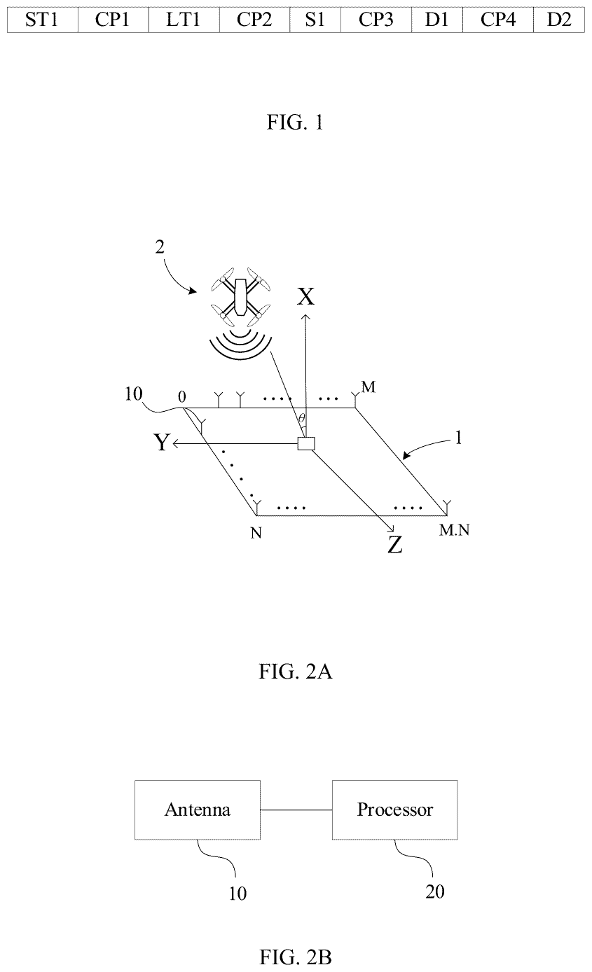

In a wireless communication system, data would be divided into a plurality of frames, and each frame is transmitted from a transmitter side to a receiver side in the form of bit streams; the configuration of the frame would be elaborated as follows. Please refer to FIG. 1, which depicts the configuration diagram of the frame. As shown in FIG. 1, in IEEE 802.11a standard wireless local area network (WLAN), the frame includes a long training symbol LT1, a short training symbol ST1, a signal symbol S1, data symbols D1 and D2 and cyclic prefixes CP1, CP2, CP3 and CP4. The long training symbol LT1, the short training symbol ST1, the signal symbol S1, the data symbols D1 and D2 are all OFDM symbols.

The long training symbol LT1 and the short training symbol ST1 are the preamble part of the frame to adjust timing sequences, detect packets and evaluate channels. The signal symbol S1 carries the transmission rate, the modulation format and the code rate of the data and is transmitted by the orthogonal sub-carriers in the OFDM system. The data symbols D1 and D2 carry the data to be transmitted and are transmitted by the orthogonal sub-carriers in the OFDM system. In addition, the signal symbol S1 and the data symbols D1 and D2 respectively have a plurality of pilot signals, and the plurality of pilot signals provides a reference for phase demodulation and are arranged between the two adjacent OFDM symbols of the signal symbol S1, between the two adjacent OFDM symbols of the data symbol D1 and between the two adjacent OFDM symbols of the data symbol D2. The orthogonal sub-carriers carry the plurality of pilot signals, the plurality of pilot signals are block type pilot patterns and appear at the specific time points of the signal symbol S1 and the data symbols D1 and D2, and the time difference of the two adjacent pilot signals is fixed.

The cyclic prefix CP1 is located between the long training symbol LT1 and the short training symbol ST1 to prevent the symbol interference between the long training symbol LT1 and the short training symbol ST1; the cyclic prefix CP2 is located between the short training symbol ST1 and the signal symbol S1 to prevent the symbol interference between the short training symbol ST1 and the signal symbol S1; the cyclic prefix CP3 is located between the signal symbol S1 and the data symbol D1 to prevent the symbol interference between the signal symbol S1 and the data symbol D1; the cyclic prefix CP4 is located between the data symbol D1 and the data symbol D2 to prevent the symbol interference between the data symbol D1 and the data symbol D2. In other words, the cyclic prefixes CP1 to the cyclic prefix CP4 serves as the guard interval (GI) between the adjacent symbols to prevent inter symbol interference (ISI).

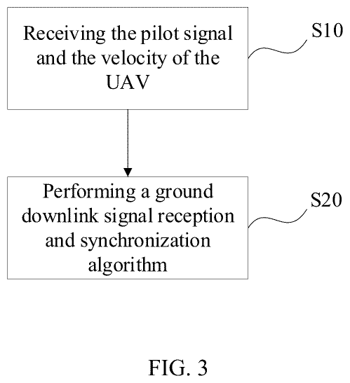

Please refer to FIG. 2A, which depicts the schematic diagram of a wireless signal reception device and a UAV according to one embodiment of the present disclosure. As shown in FIG. 2A, a wireless signal reception device 1 may be a base station disposed on the ground and communicate with the base station mounted on the UAV 2 by the OFDM system to perform bidirectional data transmission.

It should be noted that the UAV 2 has functions of capturing images, positioning, wireless communication, sensing sound and sensing temperature, i.e., the functions provided by the UAV 2 are the same as the functions provided by the current UAV. Other functions (e.g., velocity measurement and distance measurement) may be added to the functions of the UAV 2 according to actual application requirements, and the functions of the UAV 2 are not limited thereto. The base station mounted on the UAV 2 is a 5G NR small cell site.

Please refer to FIG. 2B, which depicts the configuration diagram of the wireless signal reception device according to one embodiment of the present disclosure. As shown in FIG. 2B, in conjunction with FIG. 2A, the wireless signal reception device 1 includes a plurality of antennas 10 and a processor 20. The plurality of antennas 10 constitute an antenna array, and one of the plurality of antennas 10 receives the pilot signal and the velocity of the UAV 2. It should be noted that the signal transmitted to the antenna 10 by the base station of the UAV 2 is an original pilot signal, and the original pilot signal is converted into the pilot signal due to a doppler effect; in other words, the original pilot signal is the pilot signal which does not undergo the doppler effect, and the pilot signal received by the antenna 10 is the original pilot signal after undergoing the doppler effect. The processor 20 is electrically connected to the plurality of antennas 10 and performs a ground downlink signal reception and synchronization algorithm, and the ground downlink signal reception and synchronization algorithm will be described in the corresponding paragraphs of a receiving method of a wireless signal. The processor 20 may be a central processing unit (CPU) or the other type processor and be not limited thereto.

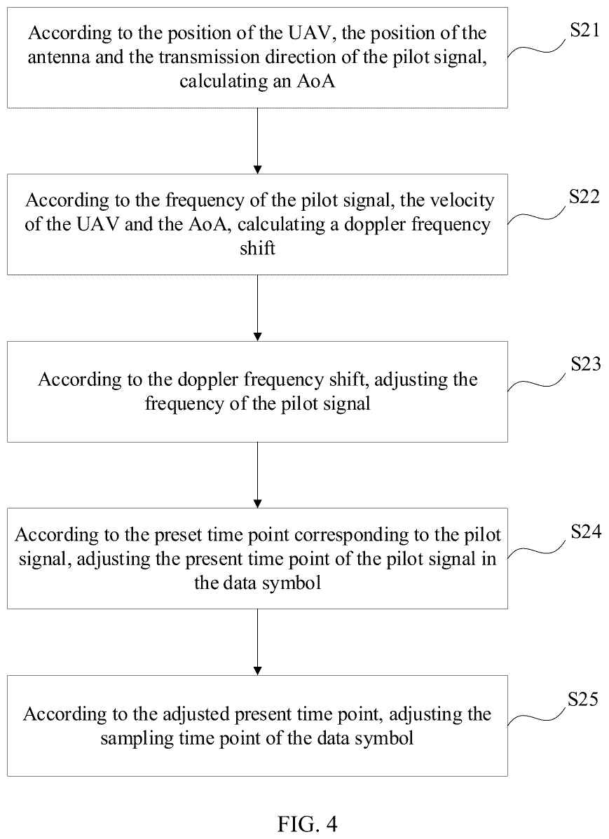

Please refer to FIG. 3, which depicts the flowchart of a receiving method of a wireless signal according to one embodiment of the present disclosure. As shown in FIG. 3, the receiving method of the wireless signal includes step S10 and step S20. The receiving method of the wireless signal shown in FIG. 3 may be applicable to the wireless signal reception device 1 shown in FIG. 2A and FIG. 2B but may be not limited thereto. For example, the step S10 and the step S20 would be explained by the wireless signal reception device 1 shown in FIG. 2A and FIG. 2B as follows.

Step S10: receiving the pilot signal and the velocity of the UAV 2. As described above, the processor 20 receives the pilot signal and the velocity of the UAV 2 by the antenna 10.

Step S20: performing a ground downlink signal reception and synchronization algorithm. Specifically, the processor 20 performs the ground downlink signal reception and synchronization algorithm on the pilot signal to perform doppler shift compensation on the pilot signal, and the problem about the signal synchronization deviations of the wireless signal reception device 1 and the UAV 2.

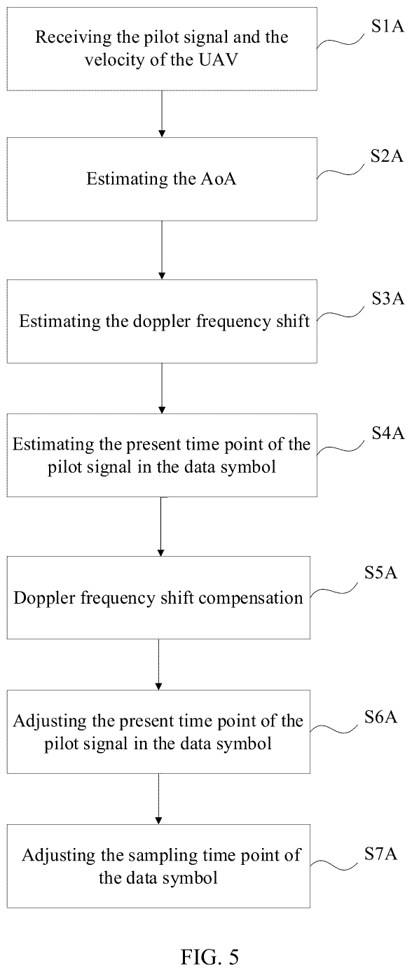

The following will introduce the ground downlink signal reception and synchronization algorithm in detail. Please refer to FIG. 4, which depicts the flowchart of the ground downlink signal reception and synchronization algorithm according to one embodiment of the present disclosure. As shown in FIG. 4, the ground downlink signal reception and synchronization algorithm includes step S21 to step S25.

Step S21: according to the position of the UAV 2, the position of the antenna 10 and the transmission direction of the pilot signal, calculating an angle of arrival (AoA) θ. Specifically, the UAV 2 measures the height of the UAV 2 relative to the ground and the distance between the UAV 2 and the antenna 10 on the transmission direction of the pilot signal and transmits the height of the UAV 2 relative to the ground and the distance between the UAV 2 and the antenna 10 on the transmission direction of the pilot signal to the processor 20, and the processor 20 calculates the AoA θ according to the height of the UAV 2 relative to the ground and the distance between the UAV 2 and the antenna 10 on the transmission direction of the pilot signal, wherein the AoA θ is the included angle between the central axis of the antenna 10 and the transmission direction of the pilot signal.

Step S22: according to the frequency of the pilot signal, the velocity of the UAV 2 and the AoA θ, calculating a doppler frequency shift. Specifically, the processor 20 generates the signal waveform diagram corresponding to the pilot signal according to the pilot signal, and obtains the frequency of the pilot signal from the signal waveform diagram of the pilot signal. Afterwards, the processor 20 substitute the frequency of the pilot signal, the velocity of the UAV 2 and the AoA θ into a formula 1 to obtain the doppler frequency shift.

$${f}_{0} = \frac{{f}_{s}}{γ ( 1 - \frac{v cos θ}{c} )} , γ = \frac{1}{\sqrt{1 - \frac{{v}^{2}}{{c}^{2}}}} \qquad ( formula 1 )$$

$$Δf = {f}_{0} - {f}_{s} = {f}_{s} \times \frac{1 - γ + γ \frac{v cos θ}{c}}{γ ( 1 - \frac{v cos θ}{c} )}$$

$$\frac{Δf}{{f}_{0}} = 1 - γ + γ \frac{v cos θ}{c} ,$$

f₀ is the frequency of pilot signal, θ is the AoA, v is the velocity of the UAV 2, c is the speed of light, fₛ is the frequency of a radio frequency signal (i.e., the original pilot signal which does not undergo the doppler effect), and γ is Lorentz factor; when the velocity of the UAV 2 is far less than the speed of light, the Lorentz factor γ is 1, and

$$Δ f ≅ {f}_{0} \times \frac{v cos θ}{c}$$

Step S23: according to the doppler frequency shift, adjusting the frequency of the pilot signal. Specifically, the processor 20 performs doppler frequency shift compensation on the pilot signal to further adjust the frequency of the pilot signal, and the frequency of the adjusted pilot signal is consistent with the frequency of the original pilot signal.

Step S24: according to the preset time point corresponding to the pilot signal, adjusting the present time point of the pilot signal in the data symbol. Specifically, the memory of the processor 20 previously stores the preset time point of the original pilot signal appearing in the data symbol (i.e., the preset time point corresponding to the pilot signal), and the processor 20 calculates the time difference between the preset time point and the present time point of the pilot signal in the data symbol and adjusts the present time point of the pilot signal in the data symbol according to the time difference.

Step S25: according to the adjusted present time point, adjusting the sampling time point of the data symbol. Due to the adjustments of the preset time point of the pilot signal in the data symbol, the starting time point and the ending time point of the data symbol change. Hence, the processor 20 adjusts the sampling time point of the data symbol according to the starting time point and the ending time point of the changed data symbol.

In the receiving method of the wireless signal of the present embodiment, the problem of the doppler frequency shifts and the frame synchronization are solved by adjusting the frequency of the pilot signal and the present time point of the pilot signal in the data symbol.

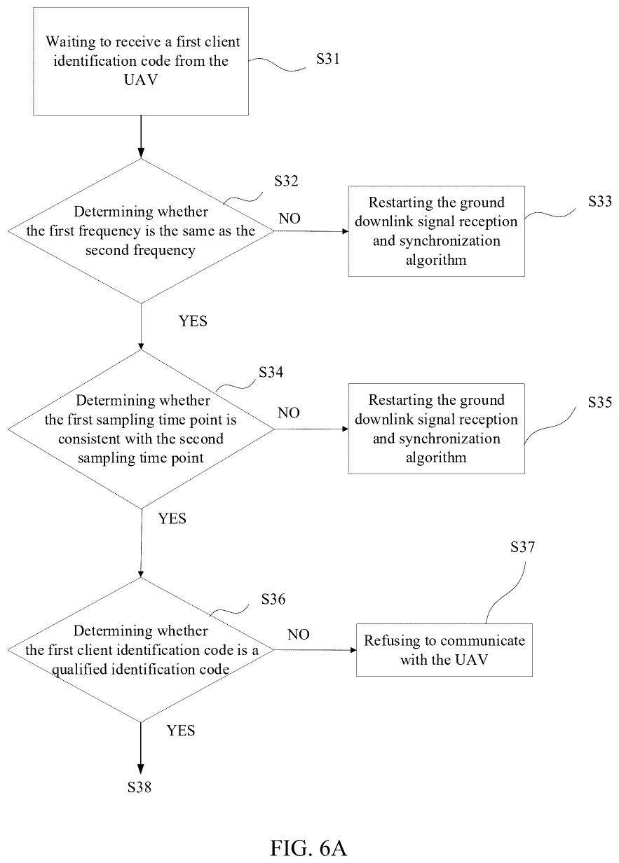

Please refer to FIG. 5, which depicts the flowchart of the receiving method of a wireless signal according to another embodiment of the present disclosure. As shown in FIG. 5, the receiving method of the wireless signal includes step S1A to step S7A. The step S1A and the step S5A are the same as the step S10 shown in FIG. 3 and the step S23 shown in FIG. 4 and would not be repeated. The receiving method of the wireless signal shown in FIG. 5 may be applicable to the wireless signal reception device 1 shown in FIG. 2A and FIG. 2B but may be not limited thereto. For example, the step S1A to the step S7A would be explained by the wireless signal reception device 1 shown in FIG. 2A and FIG. 2B as follows.

Step S2A: estimating the AoA θ. Specifically, the processor 20 estimates the distance between the UAV 2 and the antenna 10 on the transmission direction of the pilot signal and the horizontal distance between the antenna 10 and the UAV 2 according to the relative position relationship between the antenna 10 and the UAV 2, and estimates the AoA θ according to the distance between the UAV 2 and the antenna 10 on the transmission direction of the pilot signal and the horizontal distance between the antenna 10 and the UAV 2.

Step S3A: estimating the doppler frequency shift. Specifically, the memory of the processor 20 previously stores the frequency of the original pilot signal; the processor 20 generates the signal waveform diagram corresponding to the pilot signal according to the pilot signal, and obtains the frequency of the pilot signal from the signal waveform diagram of the pilot signal. Afterwards, the processor 20 estimates the difference between the frequency of the original pilot signal and the frequency of the pilot signal, and regards the foregoing difference as the doppler frequency shift. It should be noted that the step S2A and the step S3A may be synchronously performed. In addition, the processor 20 calculates the doppler frequency shift according to the frequency of the pilot signal, the velocity of the UAV 2 and the AoA θ, and verifies whether the doppler frequency shift estimated by the step S3A is correct based on the foregoing doppler frequency shift.

Step S4A: estimating the present time point of the pilot signal in the data symbol. Specifically, the processor 20 obtains the data symbol including the pilot signal from the signal waveform diagram corresponding to the pilot signal, and estimates the present time point of the pilot signal in the data symbol based on the data symbol including the pilot signal.

Step S6A: adjusting the present time point of the pilot signal in the data symbol. Because the number of the original pilot signal in the pilot signal may be in plural, the number of the pilot signal in the pilot signal may be in plural, and the time interval between the two adjacent pilot signals is fixed (i.e., the OFDM symbols with a fixed number). The memory of the processor 20 previously stores the preset time point and the preset time interval of the at least one original pilot signal appearing in the data symbol; the processor 20 obtains the present time point of the pilot signal which first appears in the data symbol, calculates the time difference between the present time point of the pilot signal which first appears in the data symbol and the preset time point, and adjusts the present time point of the pilot signal which first appears in the data symbol according to the time difference. Afterwards, based on the present time point of the adjusted pilot signal which first appears in the data symbol, the processor 20 utilizes the preset time interval to calculate the present time points of the pilot signals except the present time point of the pilot signal which first appears in the data symbol.

Step S7A: adjusting the sampling time point of the data symbol. Because the present time points of the pilot signals change, the starting time point and the ending time point of the data symbol change accordingly. Hence, the processor 20 adjusts the sampling time point of the data symbol according to the starting time point and the ending time point of the changed data symbol.

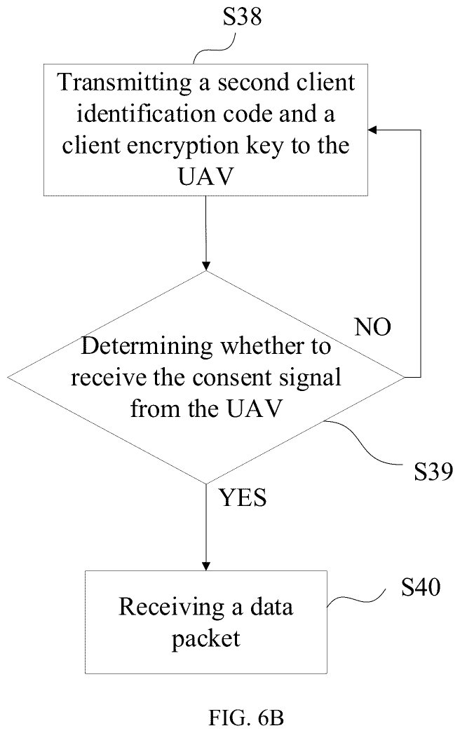

After undergoing the receiving method of the wireless signal shown in FIG. 3 and FIG. 4, the wireless signal reception device 1 shown in FIG. 2A and FIG. 2B needs to ensure the doppler frequency shift compensation, ensures whether the time synchronization of the data symbol is complete, and ensures whether the UAV is a system user. Please refer to FIG. 6A and FIG. 6B, which depict the flowchart of a step of determining whether frequency synchronization is complete and signal synchronization is complete to receive the data packet from the UAV according to another embodiment of the present disclosure. As shown in FIG. 6A and FIG. 6B, the receiving method of the wireless signal may further include the step of determining whether frequency synchronization is complete and signal synchronization is complete to receive the data packet from the UAV 2, and the step of determining whether the frequency synchronization is complete and the signal synchronization is complete to receive the data packet from the UAV 2 includes step S31 to step S40. The step S31 to the step S40 would be explained by the wireless signal reception device 1 shown in FIG. 2A and FIG. 2B as follows. For convenience of explanation, the frequency of the adjusted pilot signal is set as a first frequency, and the frequency of the original pilot signal is set as a second frequency. Correspondingly, the sampling time point corresponding to the adjusted pilot signal is set as a first sampling time point, and the sampling time point corresponding to the original pilot signal is set as a second sampling time point.

Step S31: waiting to receive a first client identification code from the UAV 2. Specifically, the processor 20 transmits a request signal to the base station of the UAV 2 to request the UAV 2 to transmit the first client identification code, and waits the UAV 2 to transmit the first client identification according to the request signal. When the processor 20 receives the first client identification code of the UAV 2 by the antenna 10, the processor 20 subsequently performs step S32; when the processor 20 does not receive the first client identification code of the UAV 2 by the antenna 10, the processor 20 keeps waiting to receive the first client identification code from the UAV 2.

Step S32: determining whether the first frequency is the same as the second frequency. Specifically, the processor 20 compares the value of the first frequency with the value of the second frequency to generate a first comparison result and determines whether the frequency synchronization is complete according to the first comparison result. When the first comparison result is that the first frequency is the same as the second frequency, the processor 20 determines that the frequency synchronization is complete and subsequently performs the step S34. When the first comparison result is that the first frequency is not the same as the second frequency, the processor 20 determines that the frequency synchronization is not complete and subsequently performs the step S33.

Step S33: restarting the ground downlink signal reception and synchronization algorithm. Specifically, the processor 20 restarts the step S21 to the step S25 shown in FIG. 4.

Step S34: determining whether the first sampling time point is consistent with the second sampling time point. Specifically, the processor 20 compares the first sampling time point with the second sampling time point to generate a second comparison result and determines whether the signal synchronization is complete according to the second comparison result. In addition, the step S34 may be performed before the step S32 or be synchronously performed with the step S32, and the performing order of the step S32 and the step S34 shown in FIG. 6A is schematic instead of limiting the present disclosure.

When the second comparison result is that the value of the first sampling time point is the same as the value of the second sampling time point, the processor 20 determines that the signal synchronization is complete and subsequently performs the step S36. When the second comparison result is that the value of the first sampling time point is different from the value of the second sampling time point, the processor 20 determines that the signal synchronization is not complete and subsequently performs the step S35.

Step S36: determining whether the first client identification code is a qualified identification code. Specifically, the memory of the processor 20 previously stores a first preset identification code, the processor 20 compares the first client identification code with the first preset identification code to generate a third comparison result and determines whether the first client identification code is the qualified identification code according to the third comparison result to determine whether the UAV 2 is the system user.

When the third comparison result is that the first client identification code is the same as the first preset identification code, the processor 20 determines that the first client identification code is the qualified identification code and the UAV 2 is the system user, and subsequently performs the step S38. When the third comparison result is that the first client identification code is different from the first preset identification code, the processor 20 determines that the first client identification code is not the qualified identification code and the UAV 2 is not the system user, and subsequently performs the step S37.

Step S37: refusing to communicate with the UAV 2. Because the UAV 2 is not the system user, the processor 20 refuses to communicate with the UAV 2.

Step S38: transmitting a second client identification code and a client encryption key to the UAV 2. Specifically, the processor 20 transmits the second client identification code and the client encryption key to the base station of the UAV 2, and the UAV 2 determines whether the wireless signal reception device 1 is a system base station according to the second client identification code and the client encryption key.

The UAV 2 stores a second preset identification code and a preset encryption key, compares the second client identification code and the client encryption key with the second preset identification code and the preset encryption key to generate a fourth comparison result, and determines whether the wireless signal reception device 1 is the system base station according to the fourth comparison result. When the fourth comparison result is that the second client identification code and the client encryption key are the same as the second preset identification code and the preset encryption key, the UAV 2 determines that the wireless signal reception device 1 is the system base station and returns a consent signal to the wireless signal reception device 1. When the fourth comparison result is that the second client identification code is different from the second preset identification code or the client encryption key is different from the preset encryption key, the UAV 2 determines that the wireless signal reception device 1 is not the system base station, and transmits a retransmission request to the wireless signal reception device 1 to request the wireless signal reception device 1 to retransmit the second client identification code and the client encryption key, or does not perform any action to wait the wireless signal reception device I to retransmit the second client identification code and the client encryption key.

Step S39: determining whether to receive the consent signal from the UAV 2. Specifically, the processor 20 determines whether the UAV 2 approves the data transmission with the wireless signal reception device 1 according to the reception situation of the consent signal.

When the antenna 10 receives the consent signal from the UAV 2, the processor 20 determines that the UAV 2 approves the data transmission with the wireless signal reception device 1 and subsequently performs the step S40. When the antenna 10 does not receive the consent signal from the UAV 2, the processor 20 determines that the UAV 2 does not approve the data transmission with the wireless signal reception device 1 and goes back to the step S38.

Step S40: receiving a data packet. Specifically, the processor 20 communicates with the UAV 2 by the processor 20 to receive the data packet.

In the receiving method of the wireless signal of the present embodiment, the step of determining whether the frequency synchronization is complete and the step of determining whether the signal synchronization is complete are further provided; when it is determined that the frequency synchronization is complete and the signal synchronization is complete, the system user identification procedure and the system base station identification procedure are performed to further determine whether the UAV is the system user and whether the wireless signal reception device is the system base station. When it is determined that the UAV is the system user and the wireless signal reception device is the system base station, the bidirectional data transmission is performed.

In view of the above descriptions, the wireless signal reception device and the receiving method of the wireless signal of the present disclosure modify the doppler frequency shift and solves the problem of frame synchronization by adjusting the frequency of the pilot signal and the sampling time point of the data symbol.

What is claimed is:

1. A wireless signal reception device, disposed on a ground and communicating with a UAV, comprising:
an antenna receiving a pilot signal and a velocity of the UAV;
a processor electrically connected to the antenna and performing a ground downlink signal reception and synchronization algorithm, wherein the ground downlink signal reception and synchronization algorithm comprises steps as follows:
according to a position of the UAV, a position of the antenna and a transmission direction of the pilot signal, calculating an angle of arrival;
according to a frequency of the pilot signal, the velocity of the UAV and the angle of arrival, calculating a doppler frequency shift;
according to the doppler frequency shift, adjusting the frequency of the pilot signal;
according to a preset time point corresponding to the pilot signal, adjusting a present time point of the pilot signal in a data symbol; and
according to the adjusted present time point, adjusting a sampling time point of the data symbol.

2. The wireless signal reception device according to claim 1, wherein the step of adjusting the present time point of the pilot signal in the data symbol according to the preset time point corresponding to the pilot signal performed by the processor comprises:
calculating a time difference between the preset time point and present time point; and
according to the time difference, adjusting the present time point of the pilot signal in the data symbol.

3. The wireless signal reception device according to claim 1, wherein the step of calculating the angle of arrival according to the position of the UAV, the position of the antenna and the transmission direction of the pilot signal performed by the processor comprises:
obtaining a height of the UAV relative to the ground and a distance between the UAV and the antenna on the transmission direction of the pilot signal from the UAV; and
according to the height and the distance, calculating the angle of arrival.

4. The wireless signal reception device according to claim 1, wherein the angle of arrival is an included angle between a central axis of the antenna and the transmission direction of the pilot signal.

5. The wireless signal reception device according to claim 1, wherein the signal transmitted to the wireless signal reception device by the UAV is an original pilot signal, and the original pilot signal is converted into the pilot signal due to a doppler effect.

6. The wireless signal reception device according to claim 5, wherein the frequency of the adjusted pilot signal is a first frequency, a frequency of the original pilot signal is a second frequency, the sampling time point corresponding to the adjusted pilot signal is a first sampling time point, a sampling time point corresponding to the original pilot signal is a second sampling time point, and the processor further performs steps as follows:
receiving a first client identification code from the UAV;
determining whether the first frequency is the same as the second frequency;
determining whether the first sampling time point is consistent with the second sampling time point;
when determining that the first frequency is the same as the second frequency and the first sampling time point is consistent with the second sampling time point, determining whether the first client identification code is a qualified identification code;
when determining that the first client identification code is a qualified identification code, transmitting a second client identification code and a client encryption key to the UAV by the antenna;
receiving a consent signal from the UAV and communicating with the UAV by the antenna to receive a data packet.

7. The wireless signal reception device according to claim 6, wherein the processor further performs a step as follows: when determining that the first frequency is not the same as the second frequency or the first sampling time point is not consistent with the second sampling time point, restarting the ground downlink signal reception and synchronization algorithm.

8. The wireless signal reception device according to claim 6, wherein the processor further performs a step as follows: when determining that the first client identification code is not the qualified identification code, refusing to communicate with the UAV.

9. A receiving method of a wireless signal, for a wireless signal reception device which comprises an antenna and a processor, is disposed on a ground and communicates with a UAV by the antenna, performed by the processor and comprising:
receiving a pilot signal and a velocity of the UAV by the antenna;
performing a ground downlink signal reception and synchronization algorithm, wherein the ground downlink signal reception and synchronization algorithm comprises steps as follows:
according to a position of the UAV, a position of the antenna and a transmission direction of the pilot signal, calculating an angle of arrival;
according to a frequency of the pilot signal, the velocity of the UAV and the angle of arrival, calculating a doppler frequency shift;
according to the doppler frequency shift, adjusting the frequency of the pilot signal;
according to a preset time point corresponding to the pilot signal, adjusting a present time point of the pilot signal in a data symbol; and
according to the adjusted present time point, adjusting a sampling time point of the data symbol.

10. The receiving method of a wireless signal according to claim 9, wherein the step of adjusting the present time point of the pilot signal in the data symbol according to the preset time point corresponding to the pilot signal performed by the processor comprises:
calculating a time difference between the preset time point and present time point; and
according to the time difference, adjusting the present time point of the pilot signal in the data symbol.

11. The receiving method of a wireless signal according to claim 9, wherein the step of calculating the angle of arrival according to the position of the UAV, the position of the antenna and the transmission direction of the pilot signal performed by the processor comprises:
obtaining a height of the UAV relative to the ground and a distance between the UAV and the antenna on the transmission direction of the pilot signal from the UAV; and
according to the height and the distance, calculating the angle of arrival.

12. The receiving method of a wireless signal according to claim 9, wherein the signal transmitted to the wireless signal reception device by the UAV is an original pilot signal, and the original pilot signal is converted into the pilot signal due to a doppler effect.

13. The receiving method of a wireless signal according to claim 12, wherein the frequency of the adjusted pilot signal is a first frequency, a frequency of the original pilot signal is a second frequency, the sampling time point corresponding to the adjusted pilot signal is a first sampling time point, a sampling time point corresponding to the original pilot signal is a second sampling time point, and the processor further performs steps as follows:
receiving a first client identification code from the UAV;
determining whether the first frequency is the same as the second frequency;
determining whether the first sampling time point is consistent with the second sampling time point;
when determining that the first frequency is the same as the second frequency and the first sampling time point is consistent with the second sampling time point, determining whether the first client identification code is a qualified identification code;
when determining that the first client identification code is a qualified identification code, transmitting a second client identification code and a client encryption key to the UAV by the antenna;
receiving a consent signal from the UAV and communicating with the UAV by the antenna to receive a data packet.

14. The receiving method of a wireless signal according to claim 13, further comprising: when determining that the first frequency is not the same as the second frequency or the first sampling time point is not consistent with the second sampling time point, restarting the ground downlink signal reception and synchronization algorithm.

15. The receiving method of a wireless signal according to claim 13, further comprising: when determining that the first client identification code is not the qualified identification code, refusing to communicate with the UAV.
